(19) United States
(12) Patent Application Publication
(10) Pub. No.: US 2006/0038474 A1
(43) Pub. Date: Feb. 23, 2006

(54) Crt with enhanced vertical resolution

(75) Inventors: Robbert Jacobus Van Wesenbeeck, Eindhoven (NL); Gerard De Haan, Eindhoven (NL); Michiel Klompenhouwer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/527,110

(22) PCT Filed: Sep. 5, 2003
(86) PCT No.: PCT/IB03/03904

§ 371 Date: Mar. 8, 2005

(30) Foreign Application Priority Data
Sep. 13, 2002 (EP) 0207872.6
Dec. 9, 2002 (EP) 02080174.2

(51) Int. Cl. H01J 29/50

(52) U.S. Cl. 313/409

(57) ABSTRACT

A color picture display device having a shadow mask is provided comprising a cathode ray tube (CRT) having a gun (1) for generating at least two electron beams mutually different colors and a display screen (2). The screen has phosphor deposits for emitting light of different colors. The device has a deflection system (3) for scanning the electron beams across the display screen (2) in a pattern of successive, substantially parallel lines, each line being scanned in a scanning direction. The device further comprises means for diverging the landing points on the screen for at least one of the beams with respect to one of the other beams in a direction other than the scanning direction, and means for interpolation of color video data, used to control the beam intensity, in order to reduce shift errors due to the diverged beams. Further, a method for operation of such a color picture display device is disclosed.

### FIELD OF THE INVENTION

The present invention relates to a color picture display device comprising a cathode ray tube (CRT) having means for generating at least two electron beams. Further, the invention relates to a method for operation of such a color picture display device.

### BACKGROUND OF THE INVENTION

Different types of cathode-ray-tubes (CRT) are known in the art. The most common type of CRT uses a so-called shadow mask for controlling the landing of the electron beams on the phosphors on the screen.

The CRTs normally use several beams that jointly scan successive lines of the display screen. In most cases three beams are used for display of the three basic colors (R, G, B), each beam landing via holes in the shadow mask on respective red, green and blue phosphors present in the display screen.

Many attempts have been made to improve the resolution and image quality in CRTs. For example, U.S. Pat. No. 4,322,750 discloses the use of motion-dependent line interpolation, U.S. Pat. No. 4,602,273 discloses the use of a progressively scanned line interlace and U.S. Pat. No. 5,260,786 discloses sequentially line interlaced scanning.

However, a reduction in spot sizes for high sharpness CRTs causes, the line structure to become more visible, especially with interlaced scanning. Thus, there is still a need for resolution enhancement in CRTs, and especially in the frame direction for the CRT. The frame direction is the direction perpendicular to the direction in which the lines are scanned on the screen. Particularly, there is a need for resolution enhancement in CRTs in which the phosphors for the three colors are deposited as sequential stripes in the line or frame direction on the screen. Further, several of the known methods for image enhancement are relatively costly and difficult to use in practice.

In the early days of television, there were some attempts with color television displays using beams slightly shifted in the frame direction during a sweep in the line direction. Such a solution is presented in, for example, U.S. Pat. No. 2,706,216. However, this known solution focused on other types of problems than the present invention, and, at that time, the requirements on CRT displays were much different from today's requirements. Further, the known solutions of this type are only usable for small display sizes. With larger sizes, the separate color stripes will be visible, which deteriorates the picture quality.

### SUMMARY OF THE INVENTION

It is therefore an object of the present invention to provide a color picture display device, and a method for operation of same, enabling an enhanced image quality to be obtained. The invention is defined by the independent claims. The dependent claims define advantageous embodiments.

The inventive device may be a CRT with a shadow mask and phosphor strips in the frame direction, wherein each of the electron beams scans its corresponding phosphor strips, while their landing points are shifted with respect to each other in the frame direction, and interpolation is preformed of the color component data for driving the respective beams in order to provide the color component data corresponding with the shift in frame direction. However, the invention may likewise be used for CRTs with phosphor strips arranged in other ways, such as in the line direction, or in other types of groupings, such as CRTs with dotted shadow masks, e.g. described in U.S. Pat. No. 4,491,863.

The inventive device may also be a CRT without a shadow mask, such as a tracking picture tube.

With the present invention, the image quality and resolution in a CRT could be greatly enhanced at moderate cost.

The basic idea is to distribute the color lines as equidistantly as possible over the fields of an image, in such a way that the color lines of the even and the odd fields are interleaved. The means for diverging the landing points may be a quadrupole mounted on the neck of the cathode ray tube. The color beams may be diverged flexibly, and the beam spots may overlap each other and scanning patterns both for interlaced and progressive scanning may be enhanced. The proposed scanning patterns result in an enhancement in line structure for both still and moving images. The newly introduced patterns behave to a certain degree as a progressive scan pattern, so that both line crawl and detail flicker are reduced.

In an embodiment the color video data used to control the beam intensity is interpolated in order to reduce or compensate for the shift of the landing points of the beams. This may be accomplished in that the video signal is de-interlaced, and after that, interpolations between frames are performed to compensate for the shift with respect to the original scan line positions. The de-interlacing would normally be de-interlacing from fields to frames, and in the interpolation of individual color signals a poly-phase filter could be used to eliminate phase errors caused by the shift of the beams. Alternatively, a memory to store only one or a few lines of the video signal may be used. The data of the stored lines are then used for the interpolations.

In a preferred embodiment, the phosphor deposits for each color are arranged along essentially parallel lines in a deposit direction, which is different from the scanning direction, wherein the means for diverging the landing points on the screen diverges the beams in the deposit direction. Preferably, the scanning direction and the deposit direction are substantially perpendicular.

The display device may comprise means for generating at least three beams, in which case, in the direction other than the scanning direction, the landing points on the screen for at least two of the beams converge. For still pictures, the perceived resolution then is very good. If on an average, the brightness of the two converging colors roughly sum up to the brightness of the non-converged color, this way of scanning is perceived by the human visual transfer system as a progressive scanning pattern. A favorable property of progressive scanning is that moving objects are not sensitive to line crawl. Another advantage of this scanning scheme is that for a white horizontal line, the amplitude of the luminance is distributed over the fields in the frame, so the luminance of this line is generated at the field rate, which is higher than the frame rate. This results in reduced detail flicker compared to a normal interlaced pattern.

The invention may be applied to a display device operating in an interlaced manner. In this way, the frame rate is doubled compared to progressive scanning, while the line frequency and the video bandwidth are kept constant. A higher frame rate is advantageous for visual perception, since the human eye is more sensitive to large area flicker than to detail flicker. Interlaced scanning reduces large area flicker, at the expense of increased detail flicker. The invention may also be applied to a display device operating in a progressive manner.

Many different types of interpolation means are feasible. E.g. a filter could be arranged for interpolation of the color component data for driving one of the beams. Alternatively, digital interpolation means may be used comprising a line or frame memory.

These and other aspects of the invention will be apparent from and elucidated with reference to the embodiments described hereinafter.

### BRIEF DESCRIPTION OF THE DRAWINGS

In the drawings:

FIG. 1 is a schematic view of a color picture display device according to an embodiment of the invention;

FIG. 2 is a schematic illustration of scanning patterns in accordance with the prior art, where FIG. 2a illustrates an interlaced scanning pattern and FIG. 2b a progressive scanning pattern;

FIG. 3 is a schematic illustration of an interlaced scanning pattern according to a first embodiment of the present invention;

FIG. 4 is a schematic illustration of an interlaced scanning pattern according to a second embodiment of the present invention;

FIG. 5 is a schematic illustration of an interlaced scanning pattern according to a third embodiment of the present invention;

FIG. 6 is a schematic illustration of an interlaced scanning pattern according to a fourth embodiment of the present invention;

FIG. 7 is a schematic illustration of a progressive scanning pattern according to a fifth embodiment of the present invention;

FIG. 8 is a schematic illustration of a progressive scanning pattern according to a sixth embodiment of the present invention;

FIG. 9 is a schematic illustration of a first type of interpolation means usable in accordance with the present invention;

FIG. 10 is a schematic illustration of a second type of interpolation means usable in accordance with the present invention;

FIG. 11 illustrates the effect of a magnetic field of a quadrupole on the landing points of the beams, as seen by a viewer in front of the screen;

FIG. 12 is a schematic view of a part of a cathode ray tube with a magnetic quadrupole;

FIGS. 13a and 13b are cross sections in the vertical pane of FIG. 12, illustrating the diverging of the beams by magnetic fields; and

FIG. 14 illustrates an embodiment according to the invention with a rotation coil and a quadrupole.

### DESCRIPTION OF PREFERRED EMBODIMENTS

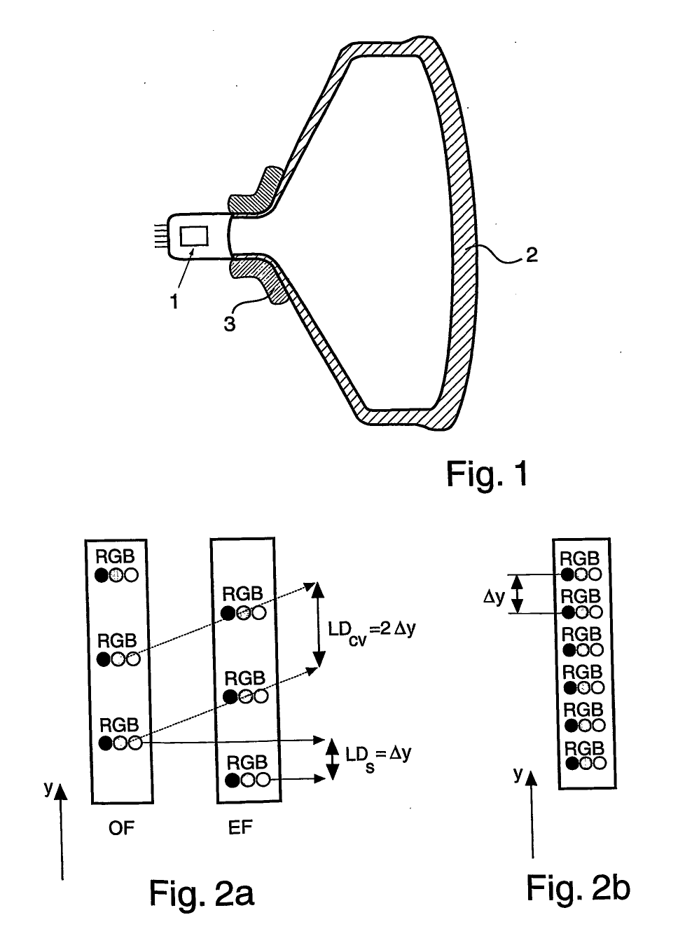

With reference to FIG. 1, the invention generally relates to a color picture display device comprising a cathode ray tube (CRT) having a gun 1 for generating one or more electron beams, a display screen 2 and a deflection unit 3 for deflecting the electron beams across the display screen. The display screen preferably comprises a plurality of phosphor elements to form different colors, preferably red, green and blue. Each color group of phosphor elements forms a pattern on the screen, for example a plurality of parallel lines. The CRT is of the traditional type using a shadow mask.

The phosphor lines are preferably arranged as stripes in the frame direction on the screen. Other arrangements, such as stripes in a line direction, or in other words in a line scanning direction are possible as well.

In a traditional color CRT with an in-line electron gun, the electron beams for the primary colors red, green and blue land on the same line of the screen, as is illustrated in FIG. 2 with the landing points R, G, B. The circles in FIG. 2 up to and including FIG. 8 with different shadings indicate landing points R, G, B of the respective red, green and blue electron beams. If beams land on the same lines in line scanning directions, the landing points R, G, B are indicated by two or more circles next to each other in a horizontal direction in the drawings. In the vertical direction of the drawing, locations of the landing points in the frame direction, indicated by arrow y, are shown. In embodiments wherein landing points differ between odd fields OF and even fields EP, two subsequent fields are shown. Traditionally, the screen is sequentially scanned line by line, from one end to the other. Such progressive scanning is illustrated in FIG. 2b. The distance Δy is the distance between two subsequent frame lines in the frame direction. With interlaced scanning, as depicted in FIG. 2a, first, for example, the odd field OF containing the odd lines of video data is scanned line by line (the left hand image of FIG. 2a), and after that the field EF containing the even lines are scanned (right hand image of FIG. 2a), thereby creating an interleaved line pattern. In this way, the frame rate is doubled compared to progressive scanning, as is illustrated in FIG. 2b, while the line frequency and the video bandwidth are kept constant. A higher frame rate is advantageous for the visual perception, since the human visual transfer system is more sensitive to large area flicker than to detail flicker. Interleaved scanning reduces large area flicker at the expense of increased detail flicker.

One of the trends in CRT design is to increase the display resolution. Therefore, the spot size (the cross-section of the electron beams on the screen) must be reduced. In doing so, the line scan structure becomes more visible both for interleaved and progressive pictures. With interlaced scanning also the so-called line crawl artifact becomes more dominant. The line crawl typically occurs in image areas without detail (further referred to as flat areas). When the viewer tracks an object at a vertical odd speed, the line structure becomes visible because the lines of two subsequent fields are seen at the same position (not ‘interlaced’). This means that a flat area is no longer perceived as flat, but can be seen to consist of discrete lines. The line crawl is also visible if there is no motion in the image (e.g. in a fill white image), because the viewer can still track at a vertical odd speed over the screen. This is possible because at those speeds the line structure becomes visible. The lines seem to ‘crawl’ up or down. The line crawl causes an interlaced display to have restlessness, because any sudden eye movements cause the line structure to appear. The artifact is worst at critical velocities in frame direction of an odd number of frame lines per field, causing halving of the perceived line resolution. The frame direction is the direction perpendicular to the line scanning direction on the screen. In the embodiment of FIG. 2a, the static line distance LDₛ in frame direction is Δy, and hence the line distance at the critical velocity LD_{cv} is 2Δy.

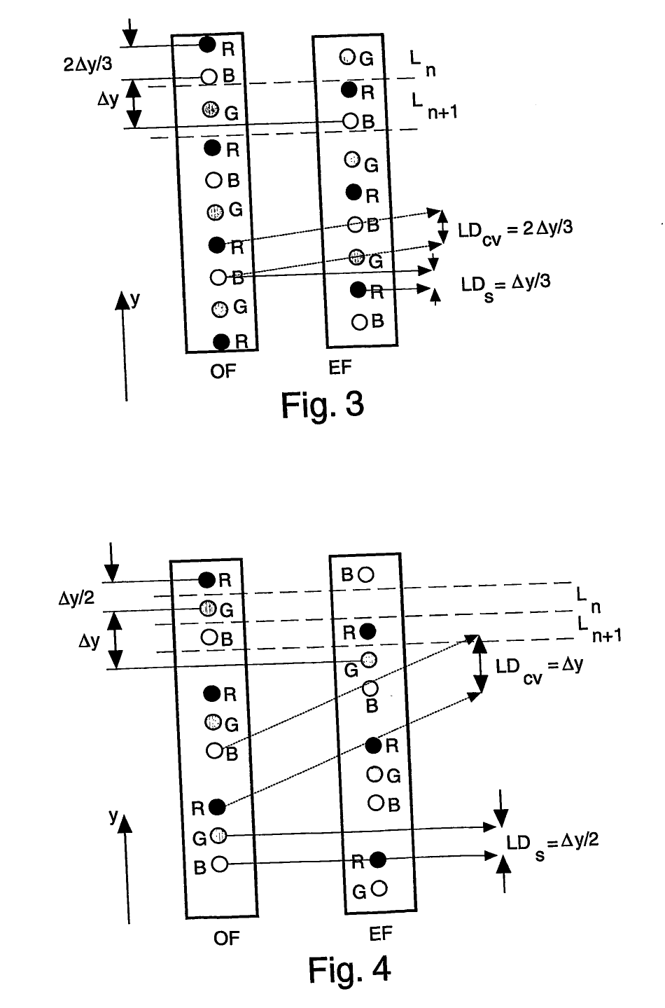

In a first embodiment using an interlaced scan pattern, as shown in FIG. 3, the electron beams for the primary colors red, green and blue trace in a line scanning direction subsequent phosphor color bars in the frame direction of the corresponding phosphor colors on the screen. The landing points R, G, B of the electron beams are spaced equidistantly in the frame direction over a distance of 2Δy/3. In an odd field OF the respective electron beams scan, for example, the respective red and blue phosphors of line Lₙ and at the same time the green phosphor of a next line Lₙ₊₁. In the subsequent even field the green phosphor of line Lₙ is scanned together with the red and blue phosphor of line Lₙ₊₁. Visibility of line structure and line crawl are reduced by distributing the scanned color lines equidistantly in the field direction, in such a way that the scanned lines of both fields are interleaved.

The landing points R and B are in this embodiment shifted by +2/3 and −2/3 of the height of a frame line Δy with respect to the landing point G for the green beam. Accordingly, for still pictures the perceived distance between two neighboring lines is reduced to Δy/3, and to 2Δy/3 for objects moving at a critical velocity of odd multiples of 1/3 frame line per field. For correct picture portrayal, the color component data for controlling the red and green beam are preferably calculated for the new positions. In the embodiment of FIG. 3, the static line distance LDₛ is Δy/3, and the line distance at the critical velocity LD_{cv} is 2Δy/3.

In a second embodiment, illustrated in FIG. 4, the green beam is at the original position, but the beams for red and blue are shifted in opposite y-directions over a distance Δy/2 of half a frame line. With still images, the line distance then becomes Δy/2. An n^{th} line Lₙ, for example, is scanned by the green beam during the odd field OF, while a n+1^{th} line Lₙ₊₁ is scanned by the blue beam during the odd field OF and by the red beam during the even field EF. The summed brightness resulting from the scanning of the red and blue beam of line Lₙ₊₁ is roughly the same as the brightness resulting from the scanning of line Lₙ of the green beam. This is based on the fact that the relative contributions to the brightness of the colors red, green and blue are approximately 0.3, 0.6 and 0.1, respectively. With objects moving at a critical velocity of an odd number of lines per frame, the maximum distance between the lines is doubled to 2× Δy/2 or one frame line. In the embodiment of FIG. 4, the static line distance LDₛ is Δy/2, so the line distance at the critical velocity LD_{cv} is Δy.

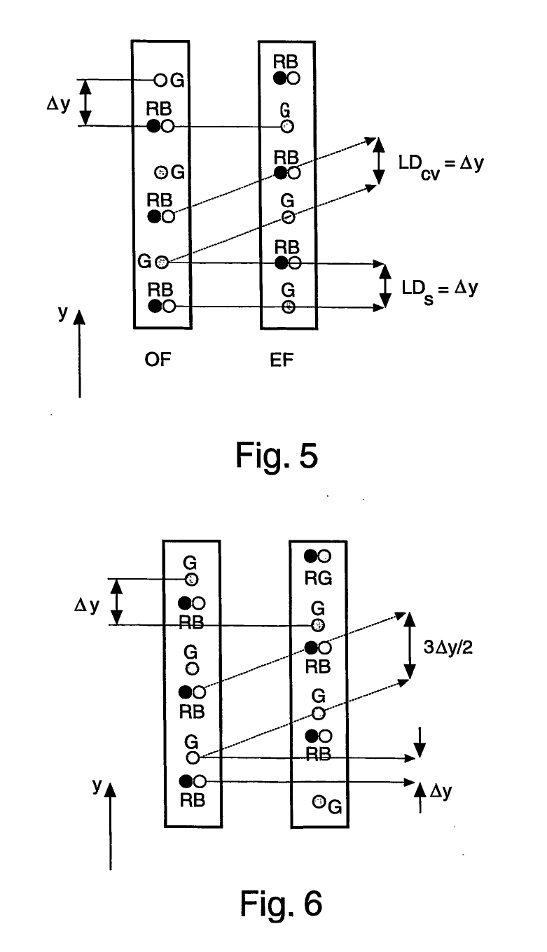

In a third embodiment, as is illustrated in FIG. 5, the green beam has the original landing point G again. Now, the red and green beams are shifted in a same direction over a same distance Δy, so over one frame line distance, with respect to the green beam, both landing on the same scanning line on the screen. For still pictures, the perceived resolution is then expected to be the same as for the pattern shown in FIG. 2a. If on an average, the brightness resulting from the red and blue beams hitting the phosphors roughly sum up to the brightness resulting from the green beam, this way of scanning looks like a progressive scanning pattern. A favorable property of progressive scanning is that moving objects are not sensitive to line crawl. Another advantage of the scanning scheme according to this embodiment is that for a white line in the line scanning direction, which would be present in only one field of the scanning pattern of FIG. 2a, part of the amplitude of the luminance is shifted to the full frame rate. This results in reduced detail flicker compared to the normal interlaced pattern in FIG. 2a. In the embodiment of FIG. 5, the static line distance LDₛ is Δy, and the line distance at the critical velocity LD_{cv} is the same, i.e. Δy.

In a fourth embodiment, shown in FIG. 6, the grouping of the color beam spots is essentially the same as in the third embodiment discussed above, but the line distance in this case is halved compared to the situation in FIG. 3. Thus, this scanning pattern results in an enhanced resolution in the frame direction for still images. The static line distance LDₛ is Δy/2, and the line distance at the critical velocity LD_{cv} is 3Δy/2, so little reduction of line crawl is expected.

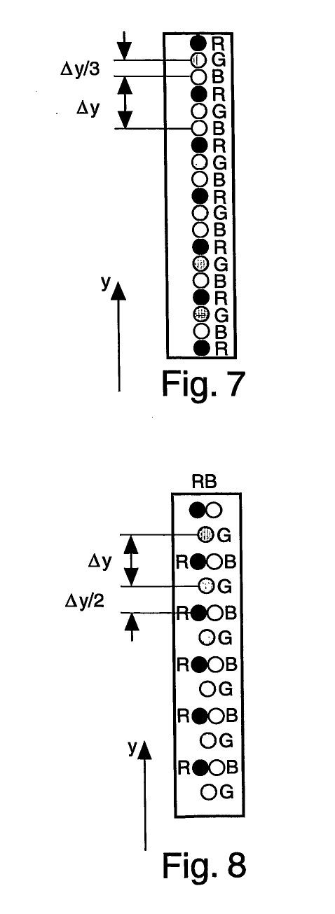

The idea underlying the present invention is also applicable to shadow mask CRTs in which the image is scanned progressively, and therefore two embodiments using progressive scanning will be discussed in the following, with reference to FIGS. 7 and 8.

In FIG. 7 the shifts of the landing points R and B in the frame direction y are +Δy/3 and −Δy/3, respectively, with respect to the landing point G. In FIG. 8, the landing points B and R are shifted in the same direction by Δy/2 with respect to G, both landing on the same line.

In the table below, properties of the interlaced and progressive scanning patterns with shifted scan line positions of R and B are gathered for comparison:

| | | Resolution for | Shift of | |
|---|---|---|---|---|
| | Resolution | objects moving | landing | Overlapping |
| | in still | at a critical | points | landing points |
| Pattern | image | velocity | R and B | within field |
| Normal interlaced | Δy | 2Δy | 0 | RGB |
| Embodiment 1 | Δy/3 | 2Δy/3 | ±Δy/3, | No |
| (FIG. 3) - | | | ∓2Δy/3 | |
| interlaced | | | | |
| Embodiment 2 | Δy/2 | Δy | ±Δy/2, | No |
| (FIG. 4)- | | | ∓Δy/2 | |
| interlaced | | | | |
| Embodiment 3 | Δy | Δy | ±Δy | RB |
| (FIG. 5)- | | | | |
| interlaced | | | | |
| Embodiment 4 | Δy/2 | 3Δy/2 | ±Δy/2 | RB |
| (FIG. 6)- | | | | |
| interlaced | | | | |
| Embodiment 5 | Δy/3 | Δy/3 | ±Δy/3, | No |
| (FIG. 7)- | | | ∓Δy/3 | |
| progressive | | | | |
| Embodiment 6 | Δy/2 | Δy/2 | ±Δy/2 | RB |
| (FIG. 8)- | | | | |
| progressive | | | | |

The critical velocities at which visibility of line crawl is at a maximum are different for the various embodiments as shown in the table above. In a system supporting variations of the landing point at video frequency, beam shifts could be changed in dependence on the amount of motion in the frame direction present locally in the video image, in such a way that line crawl is minimized.

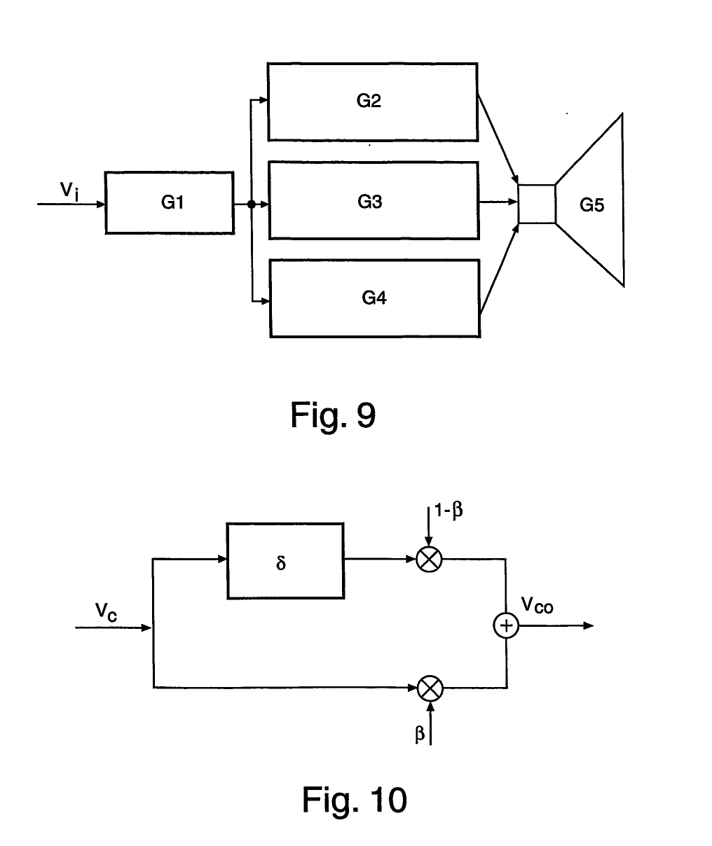

Preferably the color picture display device should further comprise means for interpolation of color video data used to control the beam intensity. By means of interpolation the video data may be calculated corresponding to the shifted landing points R, G, B. An embodiment of such interpolation means, especially suited for use with shadow mask CRTs, is illustrated in FIG. 9.

The operation of the interpolation means in this embodiment is as follows. In a first step, the video signal Vᵢ is de-interlaced in a first unit G1 from field to complete frames. In a second step (if the color in question is not shown at an integer frame line position) the individual color signals are interpolated and estimated from this progressive video signal using a poly-phase filter to eliminate the phase error between the video lines and the scan lines in the screen. In this step, the signals are preferably processed in parallel. For example, the primary red, green and blue color video signals could be processed in separate phase shift interpolators G2-G4, and finally supplied to the picture tube G5 for generating subsequent images.

The embodiment presented above is based on de-interlacing on frame basis. In a low-end TV-system e.g. a system based on a 50 Hz interlaced CRT, frame memories may be too expensive. A cheaper solution is to use memories for only one or a few lines of the colors that are shifted to different positions. The minimum amount of storage capacity for a shifted color is one line memory per beam if only shifts in the direction of the previous video line are allowed. It is to be noted that backward interpolation can be applied, using only information about a current line and one or more previous lines, to all the scanning patterns of FIGS. 3-8.

In FIG. 10, another embodiment of the interpolation means is illustrated, comprising a filter (analog or digital) to perform the interpolation for a line of a video color component shifted in the direction of the previous video line. In FIG. 10, inter-line video interpolation is used, where 0<β<1, where β is the shift towards the previous original frame line as a fraction of the original frame line distance. A video signal Vᵢ (not shown) is split into its color components V_{c}. Each color component V_{c} requiring interpolation is processed as shown in FIG. 10. The color component V_{c} is provided as an input for two branches. The first signal in a first branch is delayed in a line time delay circuit δ and then multiplied by the shift value 1-β. The other signal in the second branch is multiplied by the shift value β. Finally, the signals are added again, and the resulting signal is provided as the color component output V_{co}.

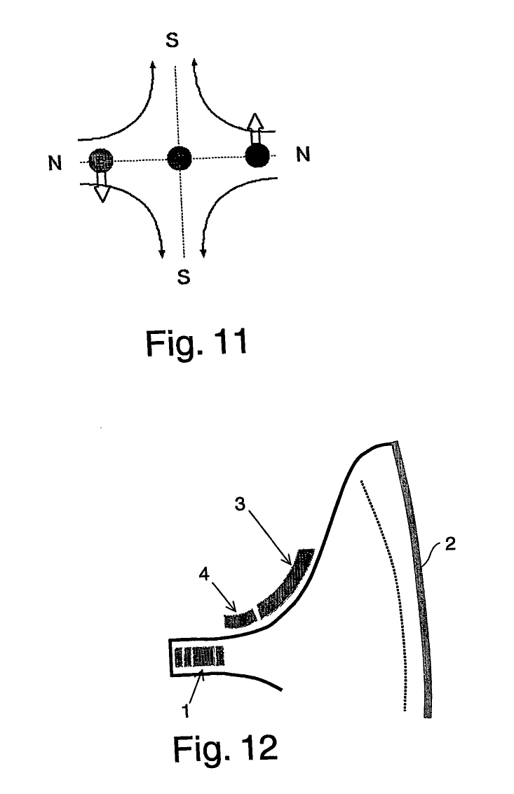

The means for diverging landing points R, G, B on the screen 2 may comprise a magnetic quadrupole 4 to split a common scan line of, for example, a red, green and blue electron beam on the screen into three separate lines, with the magnetic poles of the quadrupole 4 being arranged as shown in FIG. 11. The effect is that the landing points R, B of two side-beams are deflected downwards and upwards, respectively. The landing point of the central beam G is unaffected. The north and south poles are indicated in FIG. 11 by N or S, respectively.

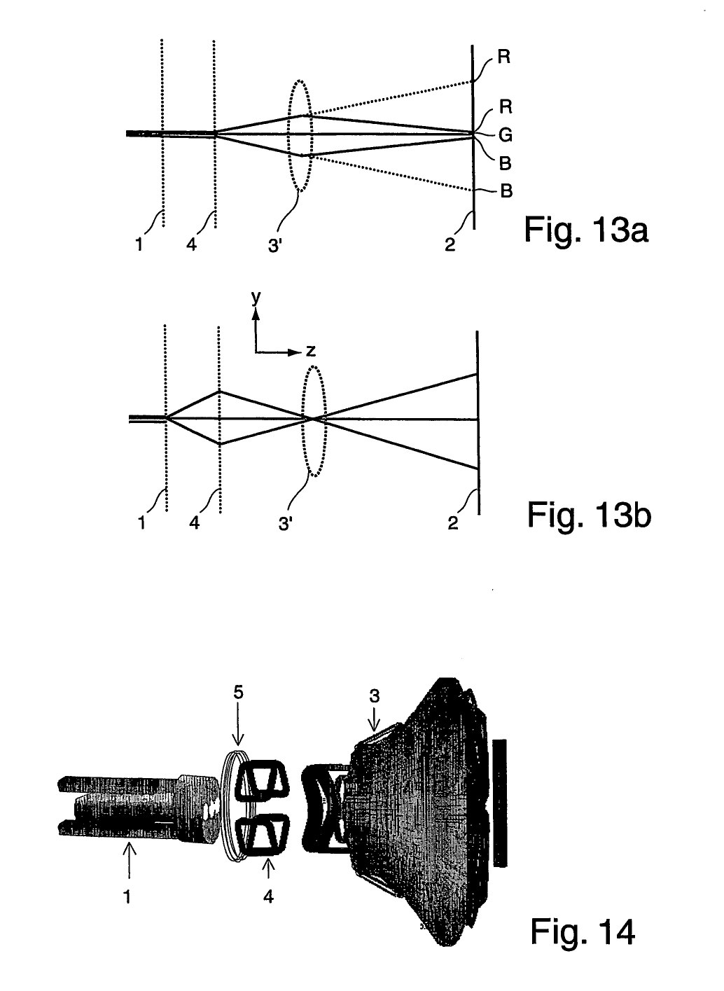

In practice, the most convenient position for the quadrupole 4 is in between the gun 1 and the deflection unit 3, as shown in FIG. 12. However, this leads to the effect depicted in FIG. 13a. Upon deflecting the electron beams in the scanning direction from left to right on the screen 2, the field of the deflection unit 3 has the effect of a lens 3′ that acts in the vertical direction. This implies that if we use a quadrupole 4 positioned in between the gun 1 and deflection unit 3 to deflect the side-beams downwards and upwards, the lens 3′ of the deflection unit 3 will counteract this effect.

This leads to the following artefact: Suppose that the quadrupole 4 generates a predetermined vertical spacing between the landing points R, G, B of the red, the green, and the blue beams, in the center of the screen 2 where the deflection unit 3 is off and hence the action of the lens 3′ is zero. Then, upon deflecting the beams, the deflection unit 3 will act as a lens and the vertical spacing between the landing points R, G, B of the beams will be reduced. So, a quadrupole 4 positioned in between the gun 1 and the deflection unit 3 will not suffice to split a scan line into three parallel scan lines for the red, green, and blue beams. There are several remedies for this problem:
Rotate the gun 1 slightly such that the beam trajectories are as depicted in FIG. 13b.
Ad a small rotation coil 5 in between the gun 1 and the quadrupole 4 as shown in FIG. 14. When sending a small current through the rotation coil 5, this current will cause rotation of the three electron beams leaving the gun 1, having the same effect as rotating the gun 1 slightly. So, this also results in the beam trajectories as depicted in FIG. 13b.
Locate the quadrupole 4 at the same location as where the action of the lens 3′ of the deflection unit 3 is located. Then the lens 3′ has no effect and a rotation coil 5 is not needed. In an embodiment, the quadrupole coils are wound around a yoke ring of the deflection unit 3.

The currents through the quadrupole and the rotation coil may be static currents (i.e. they vary as a function of time). Therefore, the quadrupole may also comprise permanent magnets.

Specific embodiments of the invention have now been described. However, several alternatives are possible, as will be apparent to someone skilled in the art. For example, different scanning schemes for the scanning path are possible. Still further, the implementation of the control method could be accomplished in different ways, for example in specially dedicated hardware or in software for control of already existing control means.

Further embodiments are described in EP application number 02078782.6 filed on 13 Sep. 2002, the priority of which is claimed herein.

In the description of the preferred embodiments above, reference has been made to specific colors. However, it will be appreciated by someone skilled in the art that in all the embodiments the primary colors are mutually interchangeable in order. Still further, it would be possible to use other colors instead of the proposed ones. Still further, the invention could also make use of a different number of color generating beams, such as only two independent beams, or four or more beams.

It should further be understood that the discussed directions merely serve as examples, and e.g. the phosphor depositions may be arranged in either the vertical or horizontal direction, or any suitable direction in between. The same applies to the scanning direction. Usually, a video line is scanned in the horizontal direction, the subsequent lines being scanned from a first line to a last line in the vertical direction. However, for the scanning patterns proposed in this invention, the physical scanning direction can be chosen arbitrarily.

Such and other obvious modifications must be considered to be within the scope of the present invention, as it is defined by the appended claims. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in the claim. The word “a” or “an” preceding an element does not exclude the presence of a plurality of such elements. Further, a single unit may perform the functions of several means recited in the claims.

1. A color picture display device comprising a cathode ray tube (CRT) having means (1) for generating at least two electron beams mutually different colors; a display screen (2), said screen having at least two different phosphor deposits for emitting light of different color when being hit by respective electron beams; means (3) for scanning the electron beams over the display screen (2) in a pattern of subsequent substantially parallel lines, each line being scanned in a scanning direction, an intensity of each of the electron beams being controllable by respective color component data; means for diverging landing points on the screen (2) for at least one of said beams with respect to another of the beams in a direction other than the scanning direction; and means for interpolation of color component data.

2. The display device of claim 1, wherein the means for interpolation interpolate the at least one of the color component data substantially proportionally to a shift of a landing point of a corresponding electron beam.

3. The display device of claim 1, wherein the phosphor deposits for each color are arranged along essentially parallel lines in a deposit direction, said deposit direction being different from the scanning direction, wherein the means for diverging the landing points on the screen diverges at least one of the beams substantially in the deposit direction.

4. The display device of claim 3, wherein the scanning direction and the deposit direction are substantially perpendicular.

5. The display device of claim 1, wherein means for generating at least three beams are present, and in said direction other than the scanning direction the landing points on the screen for at least two of said beams converge.

6. The display device of claim 1, wherein the landing points are diverged in dependence on the color component data.

7. A method for operation of a color picture display device comprising a shadow mask cathode ray tube (CRT) having at least two electron beams for mutually different colors, and a display screen (2), said screen having phosphor deposits for emitting light of different colors when being hit by respective electron beams, comprising the steps of:
scanning of the display screen by the electron beams in a pattern of subsequent, substantially parallel lines, each line being scanned in a scanning direction;
diverging landing points on the screen (2) for at least one of said beams with respect to another of the beams in a direction other than the scanning direction during said scanning;
controlling an intensity of each of the electron beams by respective color component data; and
interpolating the color component data in dependence on a shift of the landing points.
